(19) United States
(12) Patent Application Publication
(10) Pub. No.: US 2011/0039446 A1
(43) Pub. Date: Feb. 17, 2011

(54) EXTENSION CORD HOLDER

(76) Inventor: Kermit Edward Maass, San Antonio, TX (US)

Correspondence Address: Jackson Walker LLP, 112 E. Pecan, Suite 2400, San Antonio, TX, 78205, US

(21) Appl. No.: 12/784,555

(22) Filed: May 21, 2010

Related U.S. Application Data
(60) Provisional application No. 61/185,038, filed on Jun. 8, 2009.

(51) Int. Cl. H01R 13/72; F16L 3/08

(52) U.S. Cl. 439/501; 248/65

(57) ABSTRACT

An extension cord holder for holding an electrical extension cord. It has a base that includes a vertical component or leg, a standoff at the top of the leg, the standoff being generally horizontal. A slotted portion of the base runs from the removed end of the standoff down to the lower end of the leg of the base, where it makes a generally acute angle therewith. The slotted portion has a multiplicity of slots, each slot will engage one course of a looped or coiled extension cord.

This application claims the benefit of and incorporates herein by reference, U.S. Patent Application Ser. No. 61/185,038, filed Jun. 8, 2009.

### FIELD OF THE INVENTION

Extension cord holders, more specifically, an extension cord holder that sequentially locates individual coils of a long cord for easy deployment and storage.

### OBJECTS OF THE INVENTION

It is an object of the present invention to provide for a simple, easily manufactured device for holding an extension cord adjacent a support surface, such that the extension cord may be easily stored, deployed, and reengaged from the stored position.

### SUMMARY OF THE INVENTION

Applicant provides an electric extension cord holder, for holding an extension cord, which comprises a base and one or more brackets, the base having a vertical leg, a standoff portion, and a slotted portion. The slotted portion is angled and includes a multiplicity of slots defined by a multiplicity of horizontal arms, the arms spaced apart vertically and staggered.

### BRIEF DESCRIPTION OF THE DRAWINGS

FIG. 1 illustrates in side elevational view Applicant's novel electric cord holder adjacent a support surface, without the electric cord in place.

FIG. 1A is a partial view of a portion of the slots of Applicant's device.

FIG. 2 illustrates an embodiment of FIG. 1 with the electric cord engaged to the electric cord holder.

FIG. 3 illustrates a perspective view of the electric cord holder illustrating the manner in which it engages a vertical support surface, such as a wall, along with the location of an electrical outlet.

FIG. 4 is a perspective view of the device used adjacent a pole.

FIG. 5 is a side elevational view showing representative dimensions in inches.

### DETAILED DESCRIPTION OF THE PREFERRED EMBODIMENT

Applicant discloses an electric cord holder 10 whose purpose is to engage a vertical support surface, such as a wall, typically but not necessarily near an electrical outlet, and to secure and store a long electrical extension cord adjacent the wall in such a fashion that it remains untangled and is easily coiled when needing to be stored or uncoiled when needing to be used or deployed.

Electrical cord holder 10 is comprised of a base 12 and one or more brackets, here a pair 14, 16. The base includes a vertical portion or leg portion 18 for engagement adjacent a vertical support surface, such as a wall W, and typically for engagement to the wall parallel therethrough through the use of brackets 14, 16 as set forth in more detail below.

Standoff portion 20 is typically horizontal and extends from a top portion of vertical portion of leg 18 typically extending about 4-10 inches off the vertical leg.

A slotted member or portion 22 is angled with respect to the removed end of standoff portion 20 back towards the wall and typically rejoins the vertical portion or leg 18 at a bottom end thereof. Slotted portion 22 is seen to have multiple slots 24, 26, 28 (three being numbered here). The range in the number of slots depends on the size of the extension cord, but range from about 6 to about 22 or depending on need. The slots are seen to be defined by a multiplicity of typically horizontally extending, typically single member arms 30, 32, 34 (three being numbered here). Slots are typically about ¼-½ inch high and about ¼-⅜ inch wide, but may vary and would typically be about the same as or slightly larger than the diameter of the electrical cord being engaged.

The arms typically have a near end 30a/32a/34a, a removed end 30b/32b/34b, and removed faces 30c/32c/34c. The arms may also have upper surfaces 30d/32d/34d. The near end is integral to or attached to slotted portion body 20a.

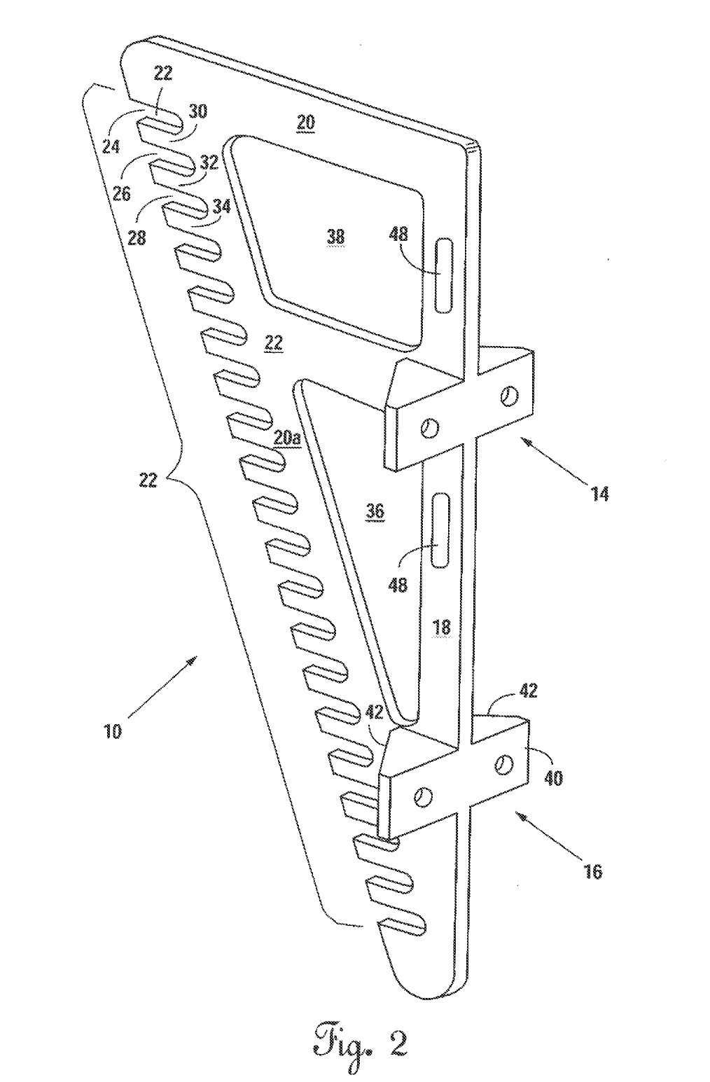

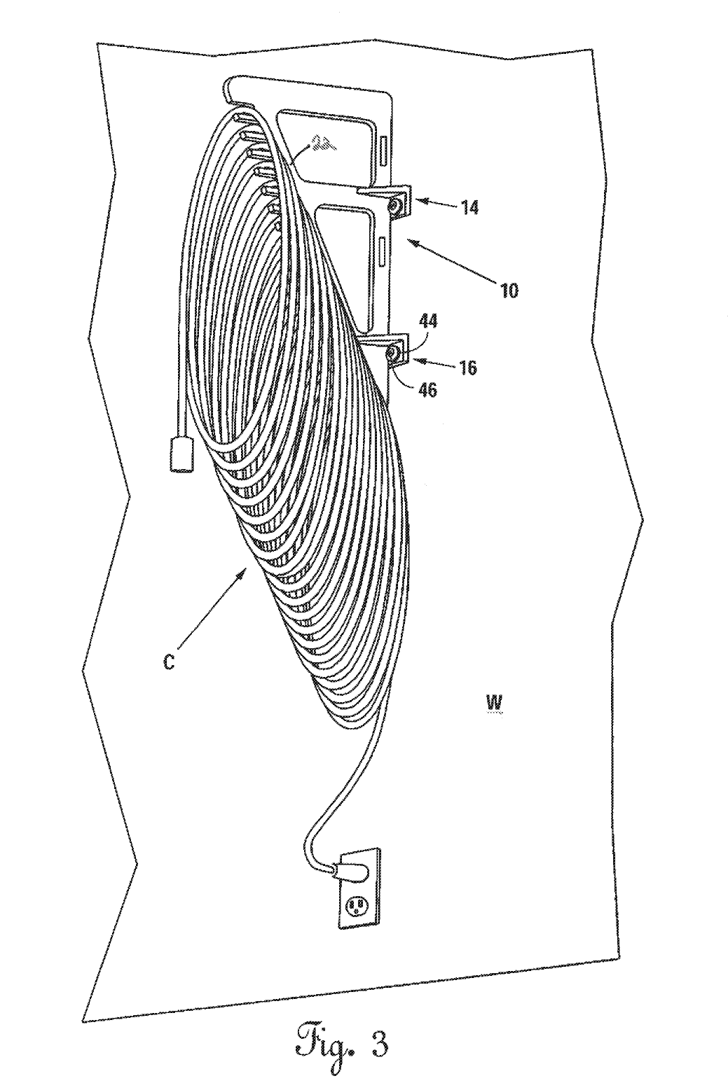

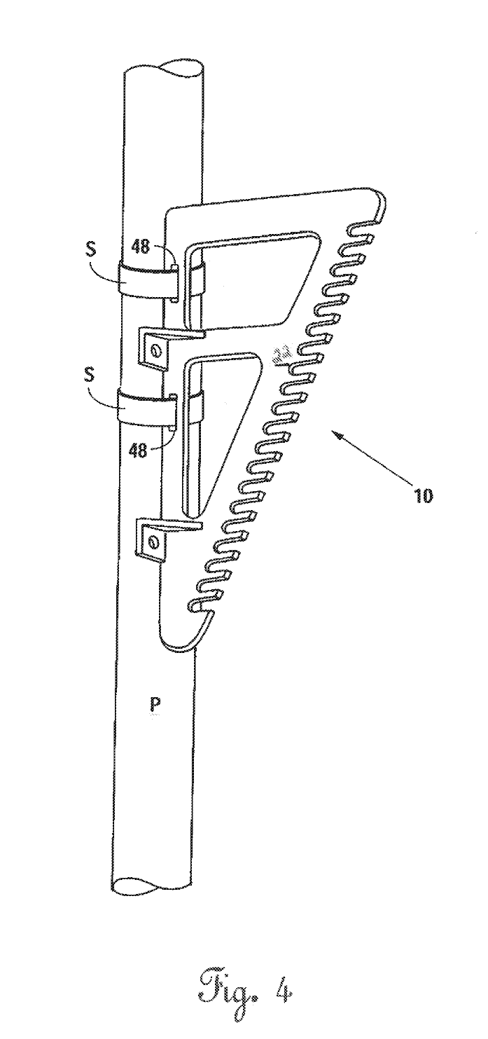

Removed ends are typically staggered or angled, one set back further or closer to the wall from the one directly below, typically the setback in the order of approximately the thickness of an extension cord, about ¼-½ inch, but may be greater. Inter-arm near end walls 20b are staggered back and may be curved to engage the walls of the extension cord. The extension cord, when in a stowed position (see FIG. 3) is pressed into the slots so it rests against or near end walls 20b. That is to say, the slotted portion has walls defining slots that, from top to bottom, are spaced vertically apart and staggered back. The length of each arm is typically approximately ¼-½ inch. The removed faces 30c/32c/34c may be either flat (or may be vertical or cut back at an angle as illustrated) or the removed faces may be curved, such as defined in a convex surface (not shown). Upper surface 30d/32d/34d may be flat or curved, curved, for example, in a convex manner.

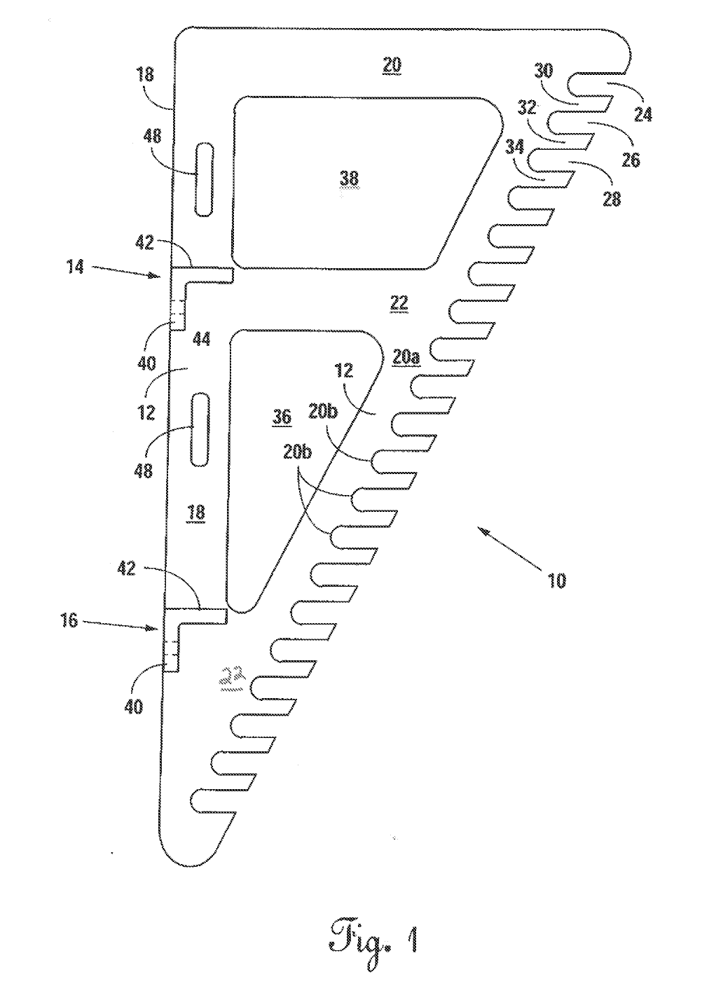

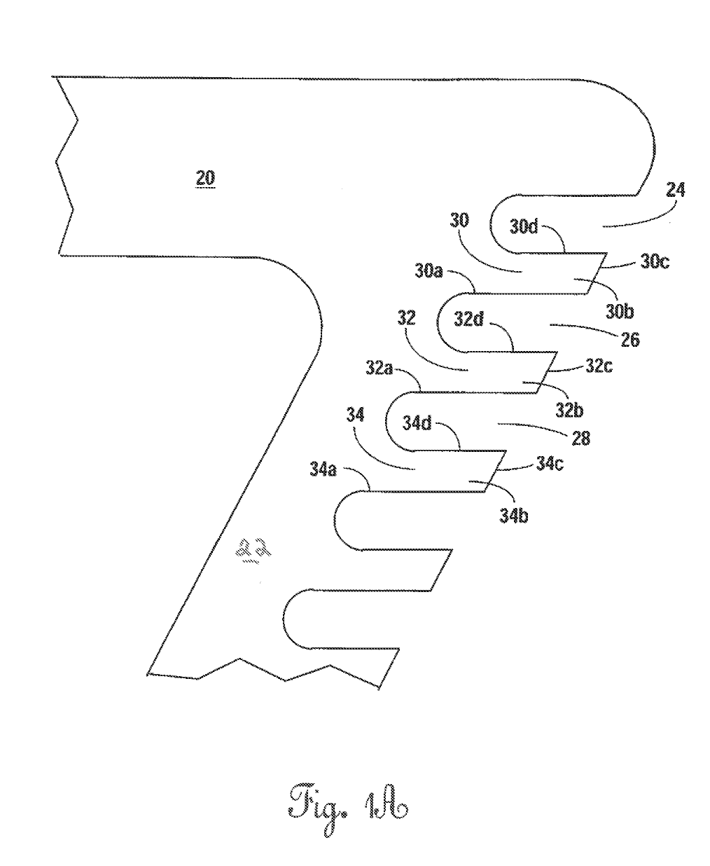

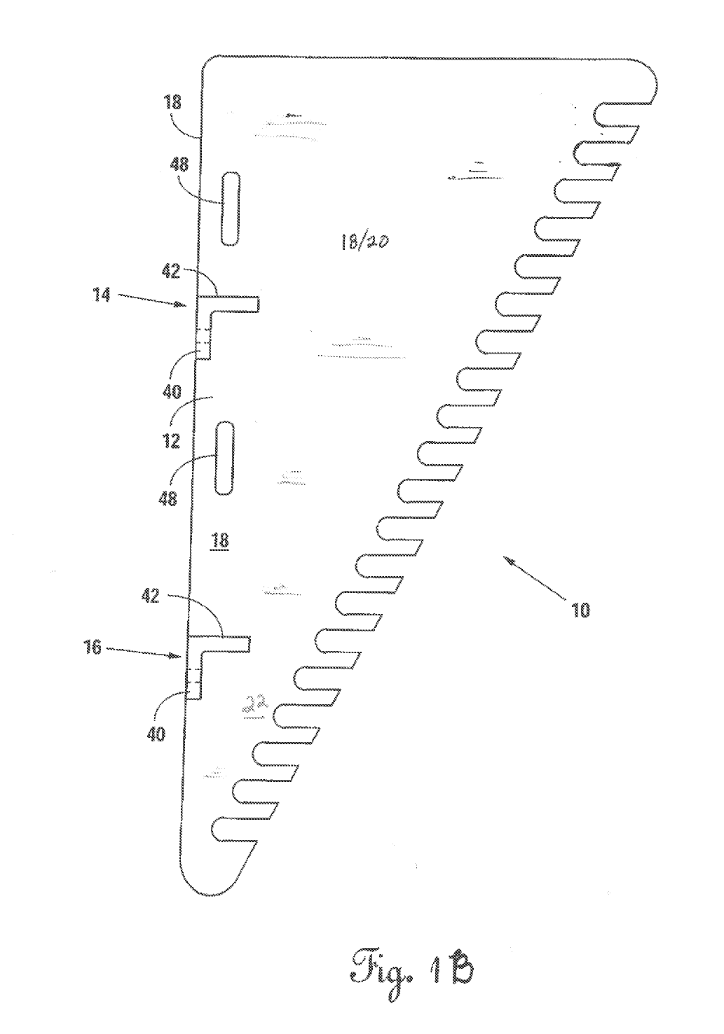

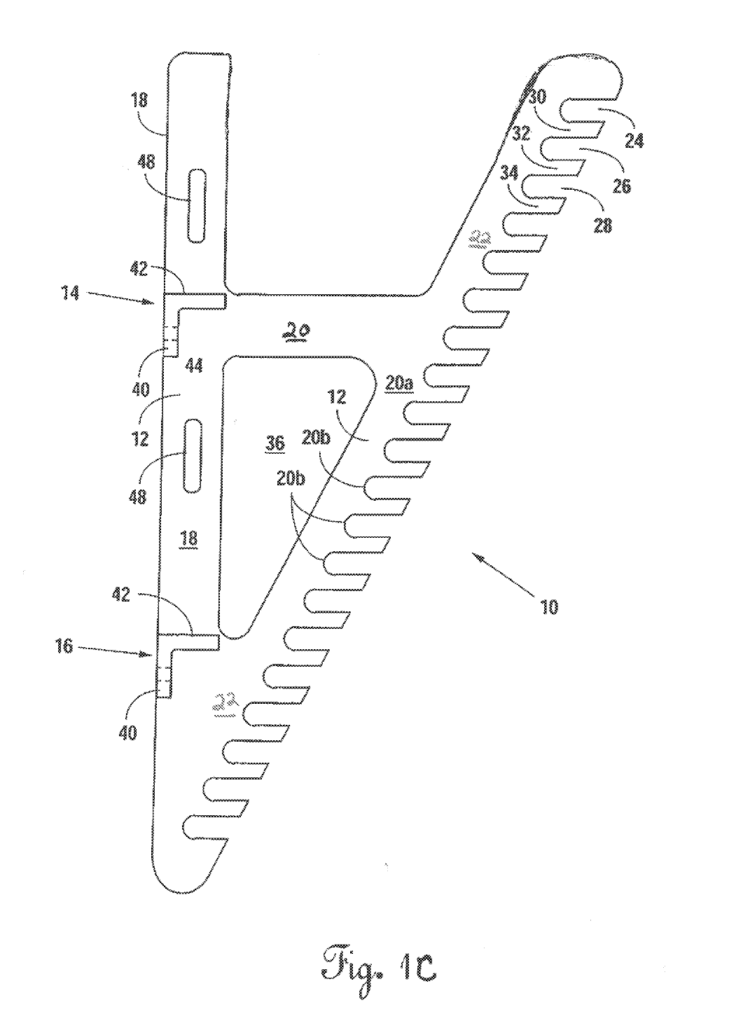

Base 12 may include, in one embodiment, one or more open areas, here two 36, 38, (FIG. 2C) or the base may be integral with the standoff, that is to say, the standoff would be with portion 18 (one-piece base) (see FIG. 1B).

Turning now to brackets 14, 16, there is seen to be adapted to hold the base adjacent a vertical support surface, such as a wall, typically but not necessarily near (just above) an electrical outlet such as seen in FIG. 3. They may be mounted up to about chest or waist height (3-6 ft.), which will allow for clean removal of the coils C as the end of the electrical cord is walked away (that is, deployed) from the stowed position on the electric cord holder 10. That is to say, when the coifs are fully engaged with electric cord holder 10 as seen in FIG. 2, removing the last or uppermost coil and grasping it near the end thereof, and subsequently walking away from the bracket, will allow each of the coils to subsequently drop from the slot the coil engages. Each slot is adapted and arranged to hold, typically a single coil, and to set back the coils one below the other when they are inserted into the slot (storage position or coiling the electric cord onto the electric cord holder 10). In reverse, when one desires to use the extension cord, deployment will sequentially uncoil as the coil sections slide out of the slots top to bottom. Moreover, the sequential deployment means that, if not all the electrical cord is necessary, then the unused portions remain stowed on the electric cord holder 10.

Turning now to the brackets 14, 16, it is seen that the brackets may include vertical portions 40, which are typically flat, for laying against the wall and may engage the base through the use of one or more support brackets 42. Here, a pair of support brackets 42 is used to engage vertical portions 40 (two illustrated in upper and lower), such that a rear surface of the vertical portions 40 is adjacent a rear surface of vertical leg portion 18, in a preferred embodiment. Support brackets 42 typically have openings 44, which may be slots or holes, dimensioned to receive a fastener 46 (screw, etc.) for engaging the bracket to a vertical support surface, such as a wall. Further, if one desires supporting the electric cord holder 10 to a vertical post or pole P, or the vertical member slots 48 (here, three shown) may be used, typically slots being formed in the vertical portion or leg 18 and near the rear surface thereof. Slots 48 are dimensioned for receipt of Velcro straps or other straps S such as elastic therein, which straps can wrap around the vertical post or vertical pole (neither straps nor pole shown), in such a manner, typically tightly thereto, so that the electric cord holder 10 may be securely engaged therewith and so that when the electric cord holder 10 has the electric cord engaged therewith, the holder will not slip or otherwise be displaced from its vertical support means.

Thus, it is seen how Applicant provides a simple, easy to use electrical cord holder which staggers multiple coils of a long electrical extension cord to allow sequential removal of the extension cord from the caddy while leaving the section of cord not needed in a coiled and substantially undisturbed configuration. It is noted that the device may be turned upside down from the position as seen in FIG. 3.

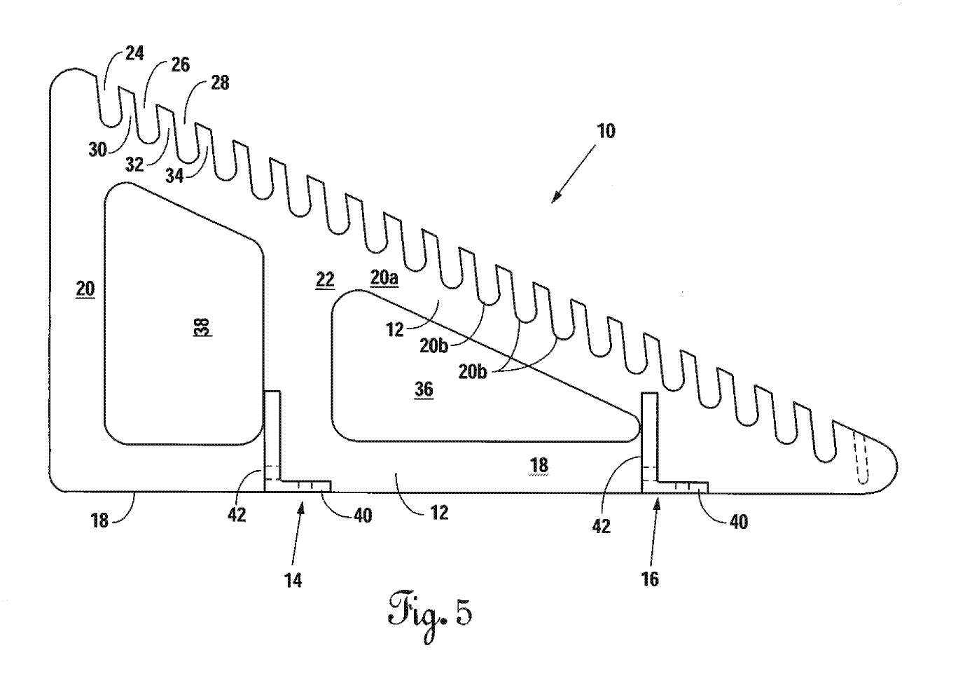

FIG. 5 illustrates some representative dimensions of an embodiment of Applicant's device, in inches.

Although Applicant's device is illustrated for holding an electrical cord, in other uses, it could hold other elongated flexible members, such as pneumatic hoses, jewelry, clothes hangers, and Christmas lights.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A cord holder comprising:
a base having a generally vertical leg having a first end and a second end,
a generally horizontal standoff at or near the first end of the vertical leg,
a slotted portion having a multiplicity of slotted members extending generally horizontally therefrom, the slotted members defining slots therebetween, the slotted portion extending generally from a removed end of the standoff to the second end of the vertical leg, and defining an acute angle with respect to the base vertical leg; and
means adapted to engage the base to a vertical support surface.

2. The cord holder of claim 1, wherein the slots number between 6 and 22.

3. The cord holder of claim 1, wherein the slots are between ¼ and ½ inch high.

4. The cord holder of claim 1, wherein the slots are between ¼ and 1 inch long.

5. The cord holder of claim 1, wherein slots are defined in part by curved walls at a near end thereof.

6. The cord holder of claim 1, wherein adjacent slots are set back between ¼ to ½ inch.

7. A cord holder comprising:
a base having a generally vertical leg having a first end and a second end,
a generally horizontal standoff at or near the first end of the vertical leg,
a slotted portion having a multiplicity of slotted members extending generally horizontally therefrom, the slotted members defining slots therebetween, the slotted portion extending generally from a removed end of the standoff to the second end of the vertical leg, and defining an acute angle with respect to the base vertical leg;
wherein the slots number between 6 and 22;
wherein the slots are between ¼ and ½ inch high.
wherein the slots are between ¼ and 1 inch long.
wherein slots are defined in part by curved walls at a near end thereof.
wherein adjacent slots are set back between 1/4 to ½ inch; and
means adapted to engage the base to a vertical support surface; wherein the slots are between ¼ and ½ inch high.

8. An assembly comprising:
an electric cord holder, the electric cord holder mounted to a support surface; and
an electrical outlet engaging the first end of the electrical cord, an electric cord having a first and a second end, wherein the electric cord is looped on the electric cord holder such that teach slot supports one course of the looped cord.
